(19) United States
(12) Patent Application Publication
(10) Pub. No.: US 2005/0044482 A1
(43) Pub. Date: Feb. 24, 2005

(54) Device and method for attaching information, device and method for detecting information, and program for causing a computer to execute the information detecting method

(75) Inventors: Kazuhiro Mino, Kanagawa-ken (JP); Akira Yoda, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/787,391

(22) Filed: Feb. 27, 2004

(30) Foreign Application Priority Data
Feb. 28, 2003 (JP) 053479/2003
Dec. 19, 2003 (JP) 423127/2003

(51) Int. Cl. G06F 15/00

(52) U.S. Cl. 715/501.1

(57) ABSTRACT

An information attaching device for attaching information to an image containing a plurality of photographed objects, and acquiring information-attached image. The information attaching device includes an information attaching part for attaching different information to each of a plurality of regions in the image that respectively contain the plurality of photographed objects, and acquiring the information-attached image.

### BACKGROUND OF THE INVENTION

1. Field of the Invention

The present invention relates to a device and method for attaching information to an image, a device and method for detecting the information attached to an image, and a program for causing a computer to execute the information detecting method.

2. Description of the Related Art

Electronic information acquiring systems are in wide use. For example, information representing the location of electronic information, such as a uniform resource locator (URL), is attached to image data as a bar code or digital watermark. The image data with the information is printed out and a print with an information-attached image is obtained. This print is read by a reader such as a scanner and the read image data is analyzed to detect the information attached to the image data. The electronic information is acquired by accessing its location. Such systems are disclosed in patent document 1 (U.S. Pat. No. 5,841,978), patent document 2 (Japanese Unexamined Patent Publication No. 2000-232573), non-patent document 1 {Digimarc MediaBridge Home Page, Connect to what you want from the web (URL in the Internet: http://www.digimarc.com/mediabridge/)}, etc.

There is also disclosed a watermark embedding method in patent document 3 (Japanese Unexamined Patent Publication No. 11 (1999)-41453). In this method, even when a photographed object in an original image with embedded information is trimmed or cut from the image, the photographed object is extracted from the image so that the information remains embedded in the image. Digital watermark information is embedded in the original image so that the photographed object and a block embedding the digital water information are in a positional relationship according to a certain rule. According to this method, because the digital watermark information is attached to the photographed object even when the photographed object is trimmed from the image, the digital watermark information attached to the original image can be read out.

On the other hand, with the rapid spread of cellular telephones, portable terminals with built-in cameras, such as cellular telephones with digital cameras capable of acquiring image data by photographing, have recently spread {e.g., patent document 4 (Japanese Unexamined Patent Publication No. 6(1994)-233020, patent document 5 (Japanese Unexamined Patent Publication No. 2000-253290), etc.}. Also, there have been proposed portable terminals having cameras incorporated therein, such as personal digital assistants (PDAs) {patent document 6 (Japanese Unexamined Patent Publication No. 8(1996)-140072), patent document 7 (Japanese Unexamined Patent Publication No. 9(1997)-65268), etc.}

By employing the above-described portable terminal with a built-in camera, favorite image data acquired by photographing can be set as wallpaper in the liquid crystal monitor of the portable terminal. The acquired image data can also be transmitted to friends along with electronic mail. When one must call off your promise or are likely to be late for an appointment, one's present situation can be transmitted to friends. For example, one can photograph their face with an apologetic expression and transmit it to friends. Thus, portable terminals with built-in cameras are convenient for achieving better communication between friends.

Also, if a print with electronic information embedded in the above-described way is photographed by a portable terminal with a built-in camera, and information on the location of the electronic information is detected, the electronic information can be acquired by accessing that location from the portable terminal.

In the case where, like a group photograph, an image contains a plurality of photographed objects, even if a photographed object is trimmed from the image the digital watermark information for the image can be obtained by referring to the remaining photographed objects according to the method disclosed in the patent document 3, because that digital watermark information is embedded in all the photographed objects. However, the watermark information that can be obtained by the method of the patent document 3 is the digital watermark information for the image, and even if any of the photographed objects is trimmed from the image, only one kind of information is obtained.

### SUMMARY OF THE INVENTION

The present invention has been made in view of the above-described circumstances. Accordingly, it is the object of the present invention to obtain a variety of information from an image containing a plurality of photographed objects.

To achieve this end, there is provided an information attaching device for attaching information to an image containing a plurality of photographed objects, and acquiring an information-attached image. The information attaching device of the present invention includes information attaching means for attaching different information to each of a plurality of regions in the image that respectively contain the plurality of photographed objects, and acquiring the information-attached image.

The aforementioned information may be attached to an image by a bar code, a numerical value, a symbol, etc. It is preferable that the information be attached to an image by being hiddenly embedded as a digital watermark.

In accordance with the present invention, there is provided an information detecting device comprising (1) input means for receiving photographed-image data obtained by photographing an image reproducing medium, in which the information-attached image acquired by the information attaching device is reproduced, with image pick-up means; and (2) detection means for detecting the information from the photographed-image data for each of the plurality of photographed objects contained in the information-attached image.

The aforementioned image reproducing medium includes various media capable of reproducing and displaying an image, such as a print containing an image, a display unit for displaying an image, etc.

The information detecting device of the present invention may further include distortion correction means for correcting geometrical distortion contained in the photographed-image data. The aforementioned detection means may be means to detect the information from the photographed-image data corrected by the correction means.

In the information detecting device of the present invention, the aforementioned image pick-up means may be a camera provided in a portable terminal.

In the information detecting device of the present invention, the aforementioned information may be location information representing storage locations of audio data correlated with the plurality of photographed objects. Also, the information detecting device may further include audio data acquisition means for acquiring the audio data, based on the location information.

In accordance with the present invention, there is provided an information attaching method of attaching information to an image containing a plurality of photographed objects, and acquiring an information-attached image. The method includes the step of attaching different information to each of a plurality of regions in the image that respectively contain the plurality of photographed objects, and acquiring the information-attached image.

In accordance with the present invention, there is provided an information detecting method comprising the steps of (a) receiving photographed-image data obtained by photographing an image reproducing medium, on which the information-attached image acquired by the aforementioned information attaching method is reproduced, with image pick-up means; and (b) detecting the information from the photographed-image data for each of the plurality of photographed objects contained in the information-attached image.

The present invention may provide programs for causing a computer to execute the information attaching method and the information detecting method.

According to the information attaching device and method of the present invention, different information is attached to each of a plurality of regions in the image that respectively contain the plurality of photographed objects, and the information-attached image is acquired. Therefore, in the information-attached image, different information is attached to each of the photographed objects contained in the image. Thus, different information can be obtained from each of the photographed objects contained in an image.

Particularly, if an information-attached image is acquired by hiddenly embedding information in an image, like a digital watermark, different information corresponding to each of photographed objects can be attached to the image so it is not deciphered. This case is preferred because information secrecy can be maintained.

According to the information detecting device and method of the present invention, an image reproducing medium, on which the information-attached image acquired by the information attaching device and method of the present invention is reproduced, is photographed with image pick-up means, and photographed-image data representing the information-attached image reproduced on the image reproducing medium is acquired. Then, the information is detected from the photographed-image data for each of the plurality of photographed objects contained in the information-attached image. Thus, different information can be obtained from each of the photographed objects contained in an image.

In the information detecting device and method of the present invention, geometrical distortion in the photographed-image data is corrected and the information is detected from the corrected image data. Therefore, even when photographed-image data contains geometrical distortion, the information embedded in an image reproduced on an image reproducing medium can be accurately detected in a distortion-free state.

When geometrical distortion in an image obtained is great as in the case of a camera provided in a portable terminal, the effect of correction of the present invention is extremely great.

In the case where the aforementioned information is location information representing storage locations of audio data correlated with a plurality of photographed objects, audio data can be obtained by accessing the storage location of the audio data, based on that location information. In this case, the user can reproduce and enjoy the audio data correlated with each of photographed objects.

### BRIEF DESCRIPTION OF THE DRAWINGS

The present invention will be described in further detail with reference to the accompanying drawings wherein:

FIG. 1 is a block diagram showing an information attaching system with an information attaching device constructed in accordance with an embodiment of the present invention;

FIG. 2 is a diagram for explaining the extraction of face regions;

FIG. 3 is a diagram for explaining how blocks are set;

FIG. 4 is a diagram for explaining a watermark embedding algorithm;

FIG. 5 is a diagram showing the state in which a symbol is printed;

FIG. 6 is a flowchart showing the steps performed in attaching information;

FIG. 7 is a simplified block diagram showing an information transmission system constructed in accordance with a first embodiment of the present invention;

FIG. 8 is a flowchart showing the steps performed in the first embodiment;

FIG. 9 is a simplified block diagram showing an information transmission system constructed in accordance with a second embodiment of the present invention;

FIG. 10 is a flowchart showing the steps performed in the second embodiment;

FIG. 11 is a simplified block diagram showing a cellular telephone relay system that is an information transmission system constructed in accordance with a third embodiment of the present invention;

FIG. 12 is a flowchart showing the steps performed in the third embodiment;

FIG. 13 is a diagram showing an image obtained by photographing means for reproducing images or voices;

FIG. 14 is a diagram showing an image with many persons obtained by photographing many images containing at least one person; and

FIG. 15 is a diagram showing an example of the photographed image of index images.

### DESCRIPTION OF THE PREFERRED EMBODIMENTS

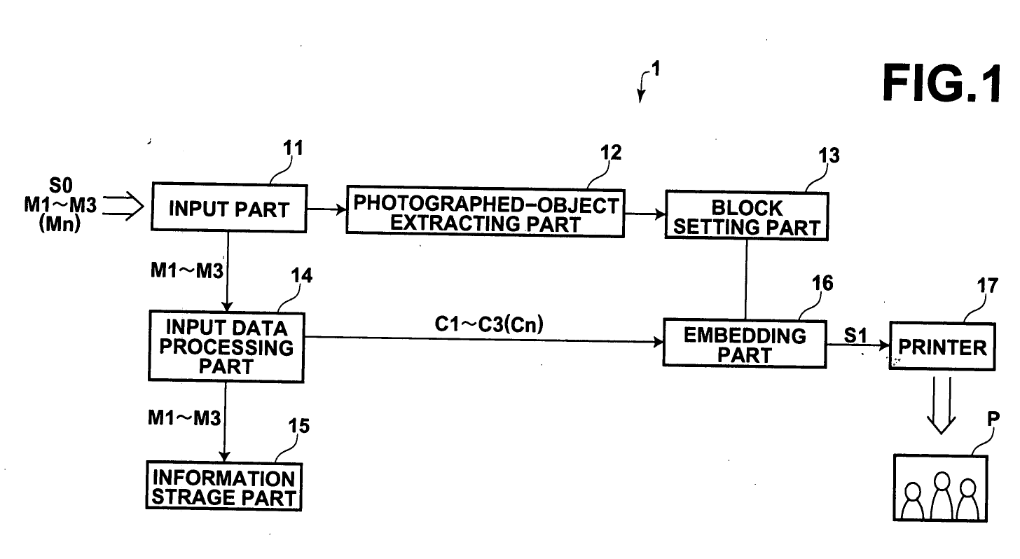

Referring to FIG. 1, there is shown an information attaching system with an information attaching device constructed in accordance with an embodiment of the present invention. As shown in the figure, the information attaching system 1 with the information attaching device is installed in a photo studio where image data S0 is printed. For that reason, the information attaching system 1 is equipped with an input part 11, a photographed-object extracting part 12, and a block setting part 13. The input part 11 receives image data S0 and audio data Mn correlated to the image data S0. The photographed-object extracting part 12 extracts photographed objects from an image represented by the image data S0. The block setting part 13 partitions the image into blocks, each of which contains a photographed object. The information attaching system 1 is further equipped with an input data processing part 14, an information storage part 15, an embedding part 16, and a printer 17. The input data processing part 14 generates a code Cn representing a location where the audio data Mn is stored. The information storage part 15 stores a variety of information such as audio data Mn, etc. The embedding part 16 embeds the code Cn in the image data S0, and acquires information-attached image data S1 having the embedded code Cn. The printer 17 prints out the information-attached image data S1.

In this embodiment, an image represented by the image data S0 is assumed to be an original image, which is also represented by S0. The original image S0 contains three persons, so the audio data Mn (where n=1 to 3) consists of audio data M1 to M3, which represent the voices of the three persons, respectively.

The audio data M1 to M3 are recorded by a user who acquired the image data S0 (hereinafter referred to as an acquisition user). The audio data M1 to M3 are recorded, for example, when the image data S0 is photographed by a digital camera, and are stored in a memory card along with the image data S0. If the acquisition user takes the memory card to a photo studio, the audio data M1 to M3 are stored in the information storage part 15 of the photo studio. The acquisition user may also transmit the audio data M1 to M3 to the information attaching system 1 via the Internet, using his or her personal computer.

There are cases where one frame of motion picture photographed by a digital video camera is printed out, or image data is reproduced from a plurality frames and the reproduced image data is printed out. In this case, the audio data M1 to M3 can employ audio data recorded along with the motion picture.

The input part 11 can employ a variety of means capable of receiving the image data S0 and audio data M1 to M3, such as a medium drive to read out the image data S0 and audio data M1 to M3 from various media (CD-R's, DVD-R's, memory cards, and other storage media) recording the image data S0 and audio data M1 to M3, a communication interface to receive the image data S0 and audio data M1 to M3 transmitted via a network, etc.

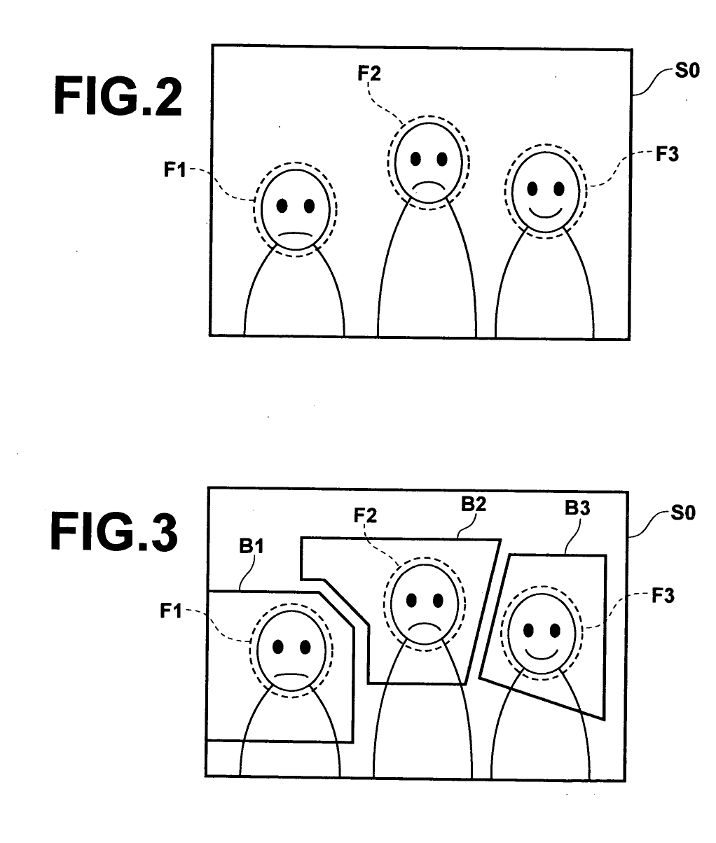

The photographed-object extracting part 12 extracts face regions F1 to F3 containing a human face from the original image S0 by extracting skin-colored regions or face contours from the original image S0, as shown in FIG. 2.

The block setting part 13 sets blocks B1 to B3 for embedding codes C1 to C3 in the original image S0 so that the blocks B1 to B3 contain the face regions F1 to F3 extracted by the photographed-object extracting part 12 and so that the face regions F1 to F3 do not overlap each other. In this embodiment, the blocks B1 to B3 are set as shown in FIG. 3.

This embodiment extracts face regions from the original image S0, but the present invention may detect specific photographed objects such as seas, mountains, flowers, etc, and set blocks containing these objects in the original image S0.

Also, by partitioning the original image S0 into a plurality of blocks on the basis of a characteristic quantity such as luminance (monochrome brightness), chrominance, etc., the blocks may be set to the original image S0 without extracting specific photographed objects such as faces, etc.

The input data processing part 14 stores the audio data M1 to M3 received by the input part 11 in the information storage part 15, and also generates codes C1 to C3, which correspond to the audio data M1 to M3. Each of the codes C1 to C3 is a uniform resource locator (URL) consisting of 128 bits and representing the storage location of each of the audio data M1 to M3.

The information storage part 15 is installed in a server, which is accessed from personal computers (PCs), cellular telephones, etc., as described later.

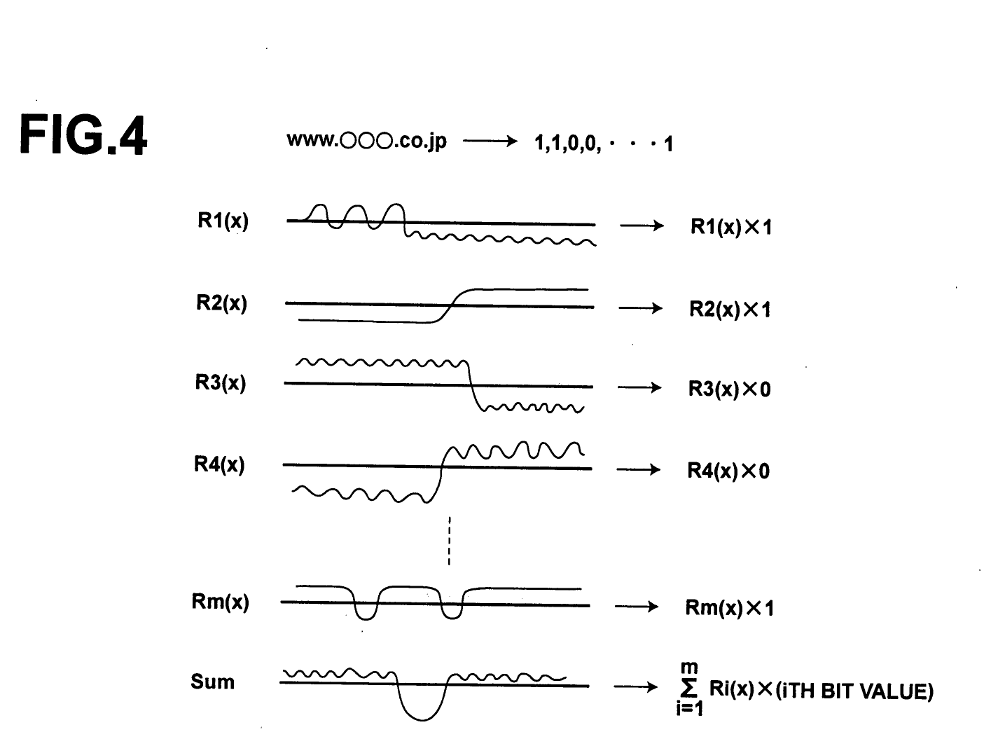

The embedding part 16 embeds codes C1 to C3 in the blocks B1 to B3 of the original image S0 as digital watermarks. FIG. 4 is a diagram to explain a watermark embedding algorithm that is performed by the embedding part 16. First, m kinds of pseudo random patterns Ri(x, y) (in this embodiment, 128 kinds because codes C1 to C3 are 128 bits) are generated. The random patterns Ri are practically two-dimensional patterns Ri (x, y), but for explanation, the random patterns Ri (x, y) are represented asone-dimensional patterns Ri(x). Next, the i^{th} random pattern Ri(x) is multiplied by the value of the i^{th} bit in the 128-bit information representing the URL of each of the audio data M1 to M3. For example, when the URL of audio data M1 is represented by code C1 (1100 . . . 1), R1(x)×1, R2(x)×1, R3(x)×0, R4(x)×0, . . . , Ri(x)×(value of the i^{th} bit), . . . , and Rm(x)×1 are computed and the sum of R1(x)×1, R2(x)×1, R3(x)×0, R4(x)×0, . . . , and Rm(x)×1 (=ΣRi(x)×i^{th} bit value) is computed. And the sum is added to the image data S0 within the block B1 in the original image S0, whereby the code C1 is embedded in the image data S0.

Similarly, for code C2, the sum of the products of the code C2 and random pattern Ri (x) is added to the image data S0 within the block B2, whereby the code C2 is embedded in the image data S0. For code C3, the sum of the products of the code C3 and random pattern Ri (x) is added to the image data S0 within the block B3, whereby the code C3 is embedded in the image data S0. The image data with the codes C1 to C3 embedded in this way is referred to as information-attached image data S1.

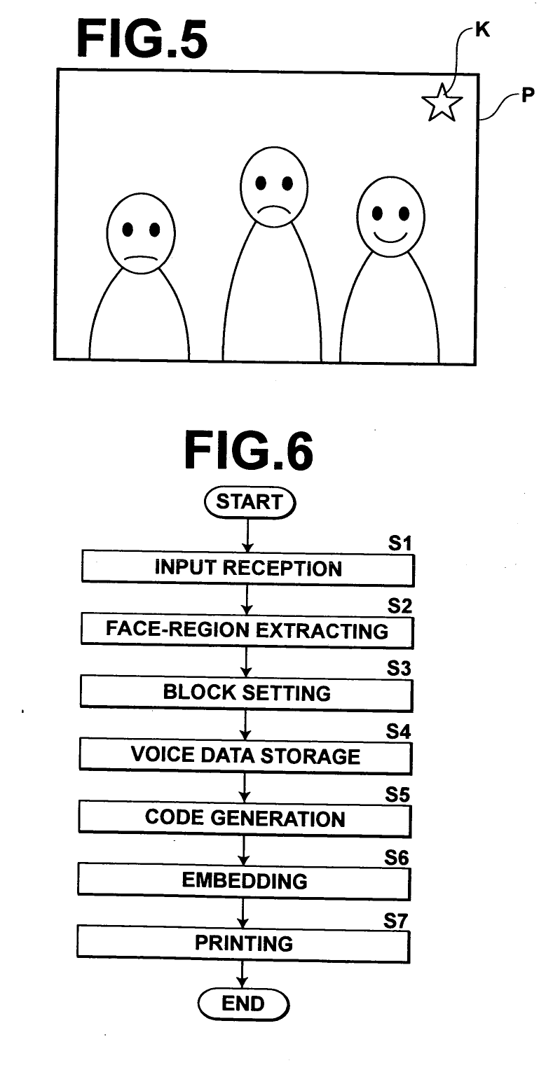

The information-attached image data S1 with the embedded codes C1 to C3 is printed out as a print P by the printer 17. Preferably, a symbol K such as ⋆, which indicates that codes C1 to C3 are embedded in the print P, is printed on the print P, as shown in FIG. 5. It is also preferable to print the symbol K on the perimeter of the print P which has no influence on the image shown in FIG. 5. Alternatively, it may be printed on the reverse side of the print P. Also, text such as “This photograph is linked with voice” may be printed on the reverse side of the print P.

Next, a description will be given of the steps performed in attaching information. FIG. 5 is a flowchart showing the steps performed in attaching information. First, the input part 11 receives image data S0 and audio data M1 to M3 (step S1). The photographed-object extracting part 12 extracts face regions F1 to F3 from the original image S0 (step S2), and the block setting part 13 sets blocks B1 to B3 containing face regions F1 to F3 to the original image S0 (step S3).

Meanwhile, the input data processing part 14 stores the audio data M1 to M3 in the information storage part 15 (step S4), and further generates codes C1 to C3 (step S5), which represent the URLs of the audio data M1 to M3. Step S4 and step S5 may be performed in reversed order, but it is preferable to perform them in parallel. Also, steps S2 and S3 and steps S4 and S5 may be performed in reversed order, but it is preferable to perform them in parallel.

Subsequently, the embedding part 16 embeds the codes C1 to C3 in the blocks B1 to B3 of the original image S0, and generates information-attached image data S1 that represents an information-attached image data having the embedded codes C1 to C3 (step S6). The printer 17 prints out the information-attached image data S1 as a print P (step S7), and the processing ends.

In the above-described embodiment, instead of a digital watermark the URLs of the audio data M1 to M3 may be attached to the image data S0 as bar codes. More specifically, bar codes may be attached in close proximity to persons contained in the original image S0. In this case, the information storage part 15 stores information correlating the bar codes with the URLs of the audio data M1 to M3.

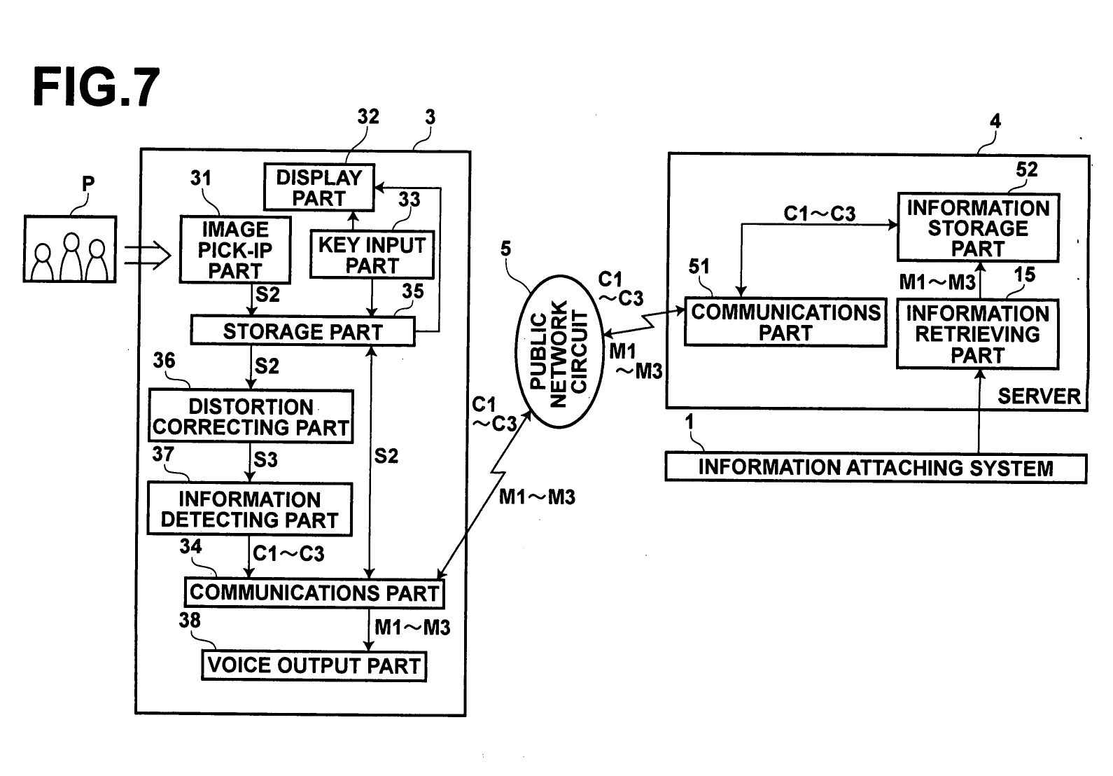

Next, a description will be given of an information transmission system equipped with a first information detecting device of the present invention. FIG. 7 shows the information transmission system with the first information detecting device, constructed in accordance with a first embodiment of the present invention. As shown in the figure, the information transmission system of the first embodiment is installed in a photo studio along with the above-described information attaching system 1. Data is transmitted and received through a public network circuit 5 between a cellular telephone 3 with a built-in camera (hereinafter referred to simply as a cellular telephone 3) and a server 4 with the information storage part 15 of the above-described information attaching system 1.

The cellular telephone 3 is equipped with an image pick-up part 31, a display part 32, a key input part 33, a communications part 34, a storage part 35, a distortion correcting part 36, an information detecting part 37, and a voice output part 38. The image pick-up part 31 photographs the print P obtained by the above-described information attaching system 1, and acquires photographed-image data S2a representing an image recorded on the print P. The display part 32 displays an image and a variety of information. The key input part 33 comprises many input keys such as a cruciform key, etc. The communications part 34 performs the transmission and reception of telephone calls, e-mail, and data through the public network circuit 5. The storage part 35 stores the photographed-image data S2 acquired by the image pick-up part 31, in a memory card, etc. The distortion correcting part 36 corrects distortion contained in the photographed-image data S2 and obtains corrected-image data S3. The information detecting part 37 acquires the codes C1 to C3 embedded in the print P, from the corrected-image data S3. The voice output part 38 comprises a loudspeaker, etc.

The image pick-up part 31 comprises a photographing lens, a shutter, an image pick-up device, etc. For example, the photographing lens may employ a wide-angle lens with f≦28 mm in 35-mm camera conversion, and the image pick-up device may employ a color CMOS (ComplementaryMetal Oxide Semiconductor) device or color CCD (Charged-Coupled Device).

The display part 32 comprises a liquid crystal monitor unit, etc. In this embodiment, the photographed-image data S2 is reduced so the entire image can be displayed on the display part 32, but the photographed-image data S2 may be displayed on the display part 32 without being reduced. In this case, the entire image can be viewed by scrolling the displayed image with the cruciform key of the key input part 33.

In the print P photographed by the image pick-up part 31, the codes C1 to C3 representing the URLs of the audio data M1 to M3 corresponding to photographed objects contained in the print P are embedded as digital watermarks by the above-described information attaching system 1.

When the print P is photographed by the image pick-up part 31, the acquired photographed-image data S2 should correspond to the information-attached image data S1 acquired by the information attaching system 1. However, since the image pick-up part 31 uses a wide-angle lens as the photographing lens, the image represented by the photographed-image data S2 contains geometrical distortion caused by the photographing lens of the image pick-up part 31. Therefore, even if a value of correlation between the photographed-image data S2 and the pseudo random pattern Ri (x, y) is computed to detect the codes C1 to C3, it does not become great because the embedded pseudo random pattern Ri (x, y) has been distorted, and consequently, the codes C1 to C3 embedded in the print P cannot be detected.

For that reason, in this embodiment, the distortion correcting part 36 corrects geometrical distortion contained in the image represented by the photographed-image data S2 and acquires corrected-image data S3.

The information detecting part 37 computes a value of correlation between the corrected-image data S3 and pseudo random pattern Ri(x, y) and acquires the codes C1 to C3 representing the URLs of the audio data M1 to M3 embedded in the photographed print P.

More specifically, correlation values between the corrected-image data S3 and all pseudo random patterns Ri(x, y) are computed. A pseudo random pattern Ri(x, y) with a relatively great correlation value is assigned a 1, and a pseudo random pattern Ri(x, y) other than that is assigned a 0. The assigned values 1s and 0s are arranged in order from the first pseudo random pattern R1 (x, y). In this way, 128-bit information, that is, the URLs of the audio data M1 to M3 can be detected.

The server 4 is equipped with a communications part 51, an information storage part 15, and an information retrieving part 52. The communications part 51 performs data transmission and reception through the public network circuit 5. The information storage part 15 is included in the above-described information attaching system 1 and stores a variety of information such as audio data M1 to M3, etc. Based on the codes C1 to C3 transmitted from the cellular telephone 3, the information retrieving part 52 retrieves the information storage part 15 and acquires the audio data M1 to M3 specified by the URLs represented by the codes C1 to C3.

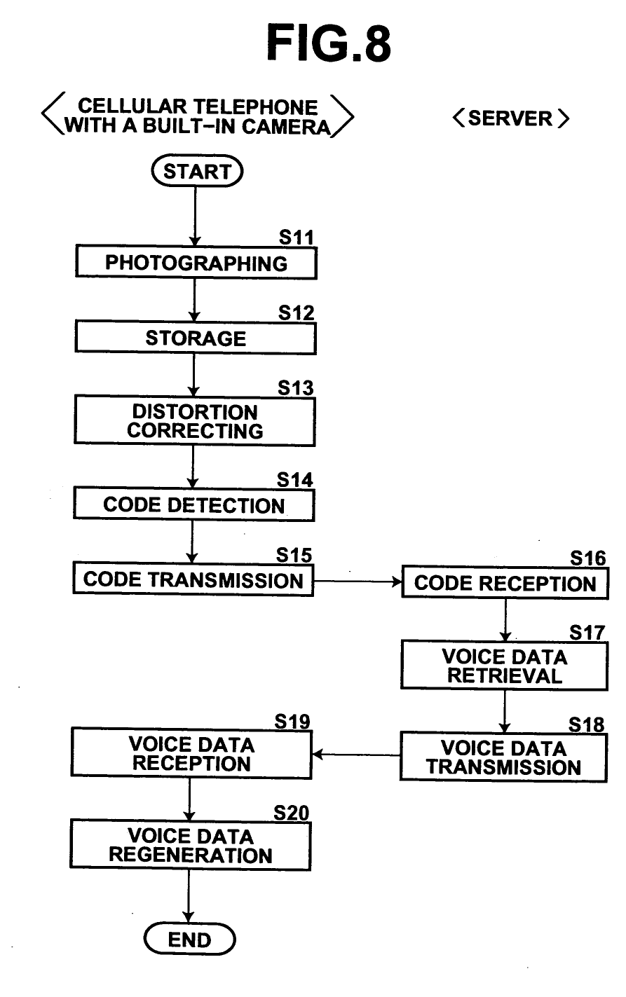

Next, a description will be given of the steps performed in the information transmission system constructed in accordance with the first embodiment. FIG. 8 is a flowchart showing the steps performed in the first embodiment. A print P is delivered to the user of the cellular telephone 3 (hereinafter referred to as the receiving user). In response to instructions from the receiving user, the image pick-up part 31 photographs the print P and acquires photographed-image data S2 representing the image of the print P (step S11). The storage part 35 stores the photographed-image data S2 temporarily (step S12). Next, the distortion correcting part 36 reads out the photographed-image data S2 from the storage part 35, also corrects geometrical distortion contained in the photographed-image data S2, and acquires corrected-image data S3 (step S13). The information detecting part 37 detects codes C1 to C3 representing the URLs of the audio data M1 to M3 embedded in the corrected-image data S3 (step S14). If the codes C1 to C3 are detected, the communications part 34 transmits them to the server 4 through the public network circuit 5 (step S15).

In the server 4, the communications part 51 receives the transmitted codes C1 to C3 (step S16). The information retrieving part 52 retrieves audio data M1 to M3 from the information storage part 15, based on the URLs represented by the codes C1 to C3 (step S17). The communications part 51 transmits the retrieved audio data M1 to M3 through the public network circuit 5 to the cellular telephone 3 (step S18).

In the cellular telephone 3, the communications part 34 receives the transmitted audio data M1 to M3 (step S19), and the voice output part 38 reproduces the audio data M1 to M3 (step S20) and the processing ends.

Since the transmitted audio data M1 to M3 are the voices of the three persons contained in the print P, the receiving user can hear the human voices, along with the image displayed on the display part 32 of the cellular telephone 3.

Thus, in this embodiment, the codes C1 to C3, representing the URLs of the audio data M1 to M3 of the photographed objects contained in the original image S0, are embedded. The information-attached image data S1 with the embedded codes C1 to C3 is printed out. The thus-obtained print P is photographed by the image pick-up part 31 of the cellular telephone 3 and photographed-image data S2 is obtained. The photographed-image data S2 is corrected and corrected-image data S3 is obtained. Next, the codes C1 to C3 are acquired from the corrected-image data S3. Thus, the receiving user can reproduce and enjoy the voices respectively corresponding to the photographed objects contained in the print P.

The geometrical distortion caused by the photographing lens of the image pick-up part 31 is corrected. Therefore, so even if the image pick-up part 31 does not have high performance and the photographed-image data S2 contains the geometrical distortion caused by the photographing lens of the image pick-up part 31, the codes C1 to C3 embedded in the image recorded on the print P are embedded in the corrected image represented by the corrected-image data S3, without distortion. Thus, the embedded codes C1 to C3 can be detected with a high degree of accuracy.

Note that in the case where the URL of audio data is recorded on the print P as a bar code, bar-code information representing a bar code is transmitted from the cellular telephone 3 to the server 4. In the server 4, the URLs of the audio data M1 to M3 are acquired based on the bar-code information, and based on the URLs, the audio data M1 to M3 are acquired and transmitted to the cellular telephone 3.

In addition, in the above-described first embodiment, the print P contains three persons, so the face region of each person may be extracted from the image represented by the photographed-image data S2 so that the receiving user can select the face of each person. More specifically, by displaying the face image of each person in order on the display part 3, or displaying them side by side, or numbering and selecting them, or attaching a frame to the face image extracted from the image represented by the photographed-image data, the receiving user may select the face image of each person. Note that in the case where the face image of each person is displayed in order on the display part 3, the extracted face image may be displayed in the original size, but it may be enlarged or reduced in size according to the size of the display part 3. In this case, it is preferable if the user can select either the extracted face image is displayed as it is, or it is displayed in enlarged or reduced size. Also, according to the size of an extracted face image, either it is displayed as it is, or it is displayed in enlarged or reduced size, may be automatically selected.

After the face image is selected, a code is detected from the face image selected by the receiving user. The detected code is transmitted to the server 4, in which only the audio data corresponding to that code is retrieved from the information storage 15. The audio data is transmitted to the cellular telephone 3.

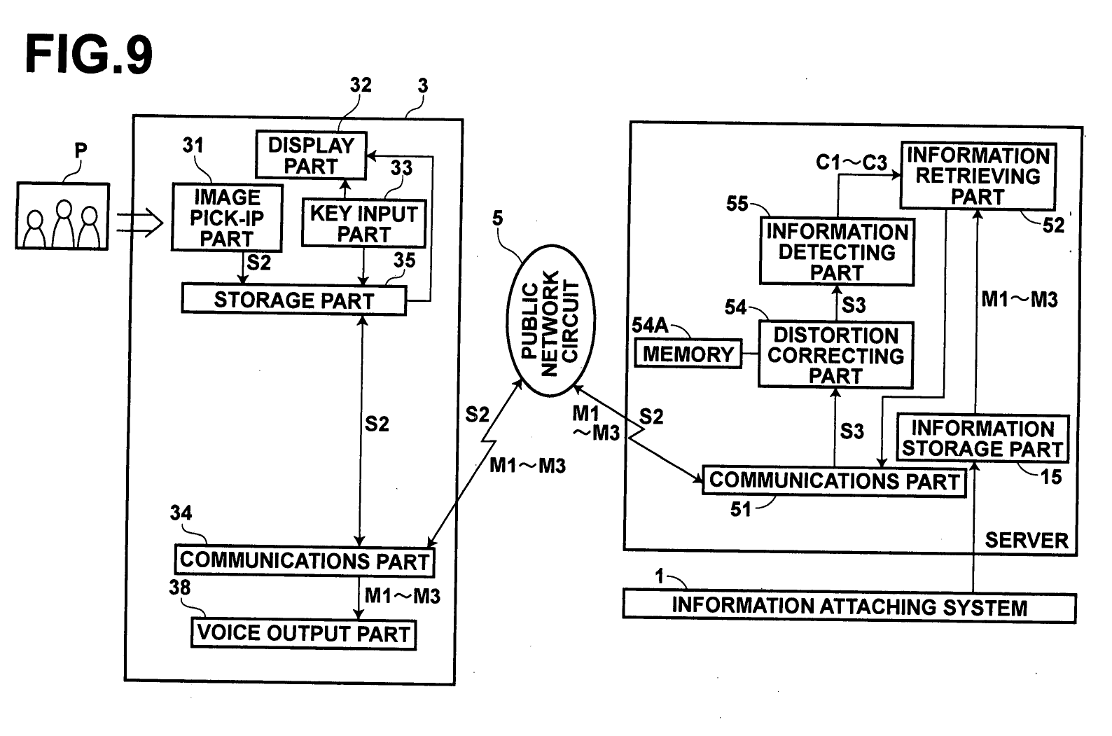

Next, a description will be given of a second information detecting device of the present invention. FIG. 9 shows an information transmission system equipped with the second information detecting device, constructed in accordance with a second embodiment of the present invention. In the second embodiment, the same reference numerals will be applied to the same parts as the first embodiment. Therefore, a detailed description will be omitted unless particularly necessary. The second embodiment differs from the first embodiment in that the photographed-image data S2 acquired by a cellular telephone 3 is transmitted to a server 4 in which codes C1 to C3 are detected. For that reason, in the second embodiment, the server 4 is equipped with a distortion correcting part 54 and an information detecting part 55, which correspond to the distortion correcting part 36 and information detecting part 37 of the first embodiment.

In the second embodiment, the distortion correcting part 54 is equipped with memory 54A, which stores distortion characteristic information corresponding to the type of cellular telephone 3. In this memory 54A, the type information and distortion characteristic information on the cellular telephone 3 are stored so they correspond to each other. Based on type information transmitted from the cellular telephone 3, distortion characteristic information corresponding to that type is read out from the memory 54A. The photographed-image data S2 is corrected based on the distortion characteristic information read out. Note that the cellular telephone 3 has an identification number peculiar to its type. For that reason, in the case where the memory 54A stores information correlating a telephone number with the type information, distortion characteristic information can be readout if the identification number of the cellular telephone 3 is transmitted.

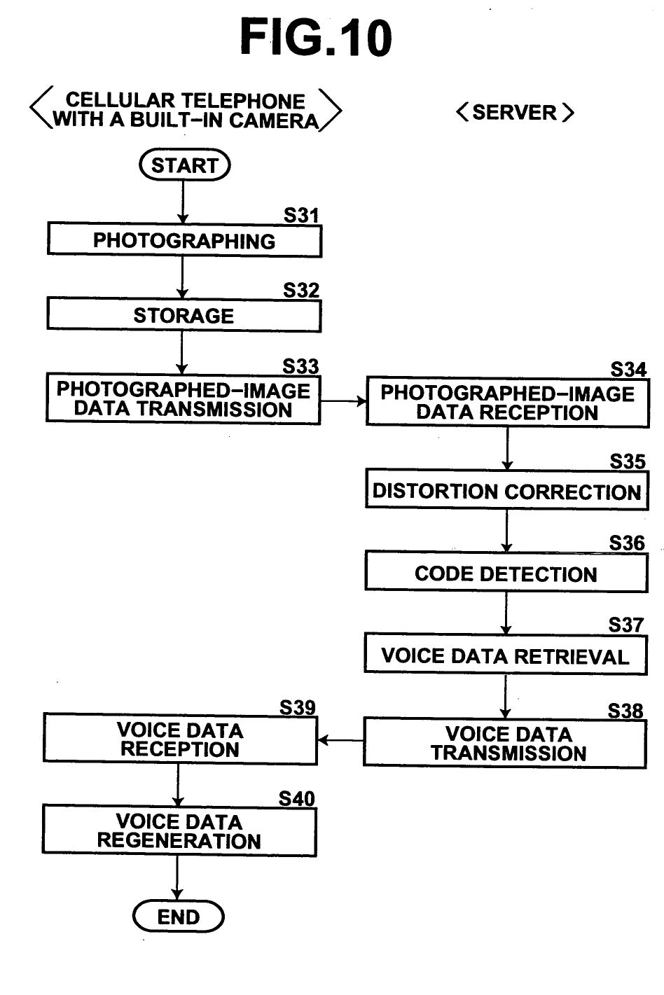

Next, a description will be given of the steps performed in the second embodiment of the present invention. FIG. 10 is a flowchart showing the steps performed in the second embodiment. A print P is delivered to the receiving user. In response to instructions from the receiving user, the image pick-up part 31 photographs the print P and acquires photographed-image data S2 representing the image of the print P (step S31). The storage part 35 stores the photographed-image data S2 temporarily (step S32). The communications part 34 reads out the photographed-image data S2 from the storage part 35 and transmits it to the server 4 through a public network circuit 5 (step S33).

In the server 4, the communications part 51 receives the photographed-image data S2 (step S34). The distortion correcting part 54 corrects geometrical distortion contained in the photographed-image data S2 and acquires corrected-image data S3 (step S35). Next, the information detecting part 55 detects codes C1 to C3 representing the URLs of audio data M1 to M3 embedded in the corrected-image data S3 (step S36). If the codes C1 to C3 are detected, the information retrieving part 52 retrieves the audio data M1 to M3 from the information storage part 15, based on the URLs represented by the codes C1 to C3 (step S37). The communications part 51 transmits the retrieved audio data M1 to M3 to the cellular telephone 3 through the public network circuit 5 (step S38).

In the cellular telephone 3, the communications part 34 receives the transmitted audio data M1 to M3 (step S39), and the voice output part 38 reproduces the audio data M1 to M3 (step S40) and the processing ends.

Since the transmitted audio data M1 to M3 are the voices of the three persons contained in the print P, the receiving user can hear the human voices, along with the image displayed on the display part 32 of the cellular telephone 3.

Thus, in the second embodiment, the server 4 detects codes C1 to C3, so the cellular telephone 3 does not have to perform the step of detecting codes C1 to C3. Consequently, the processing load on the cellular telephone 3 can be reduced compared with the first embodiment. Because there is no need to install the distortion correcting part and information detecting part in the cellular telephone 3, the cost of the cellular telephone 3 can be reduced compared to the first embodiment, and the power consumption of the cellular telephone 3 can be reduced.

The algorithm for embedding codes C1 to C3 is updated daily, but the information detecting part 55 provided in the server 4 can deal with frequent updates of the algorithm.

Note that in the case where the URL of audio data is recorded on the print P as a bar code, bar-code information representing a bar code is transmitted from the cellular telephone 3 to the server 4. In the server 4, the URLs of the audio data M1 to M3 are acquired based on the bar-code information, and based on the URLs, the audio data M1 to M3 are acquired and transmitted to the cellular telephone 3.

In addition, in the above-described second embodiment, the print P contains three persons, so the face region of each person may be extracted from the image represented by the photographed-image data S2, and instead of the photographed-image data S2 the face image data representing the face of each person may be transmitted to the server 4. More specifically, by displaying the face image of each person in order on the display part 3, or displaying them side by side, or numbering and selecting them, or attaching a frame to an extracted face image on the image represented by the photographed-image data, the face of each person can be selected. After the selection, image data corresponding to the selected face is extracted from the photographed-image data S2 as the face image data. The extracted face image data is transmitted to the server 4, in which only the audio data corresponding to the selected person is retrieved from the information storage 15. The audio data is transmitted to the cellular telephone 3.

Thus, the amount of data to be transmitted from the cellular telephone 3 to the server 4 can be reduced compared with the case of transmitting the photographed-image data S2. In addition, the calculation time in the server 4 for detecting embedded codes can be shortened. This makes it possible to transmit audio data to receiving users quickly.

Incidentally, to access the Internet or transmit and receive electronic mail with cellular telephones, cellular telephone companies provide relay servers to access web servers and mail servers. Cellular telephones are used for accessing web servers and transmitting and receiving electronic mail through relay servers. For that reason, audio data M1 to M3 may be stored in web servers, and the information attaching system of the present invention may be provided in relay servers. This will hereinafter be described as a third embodiment of the present invention.

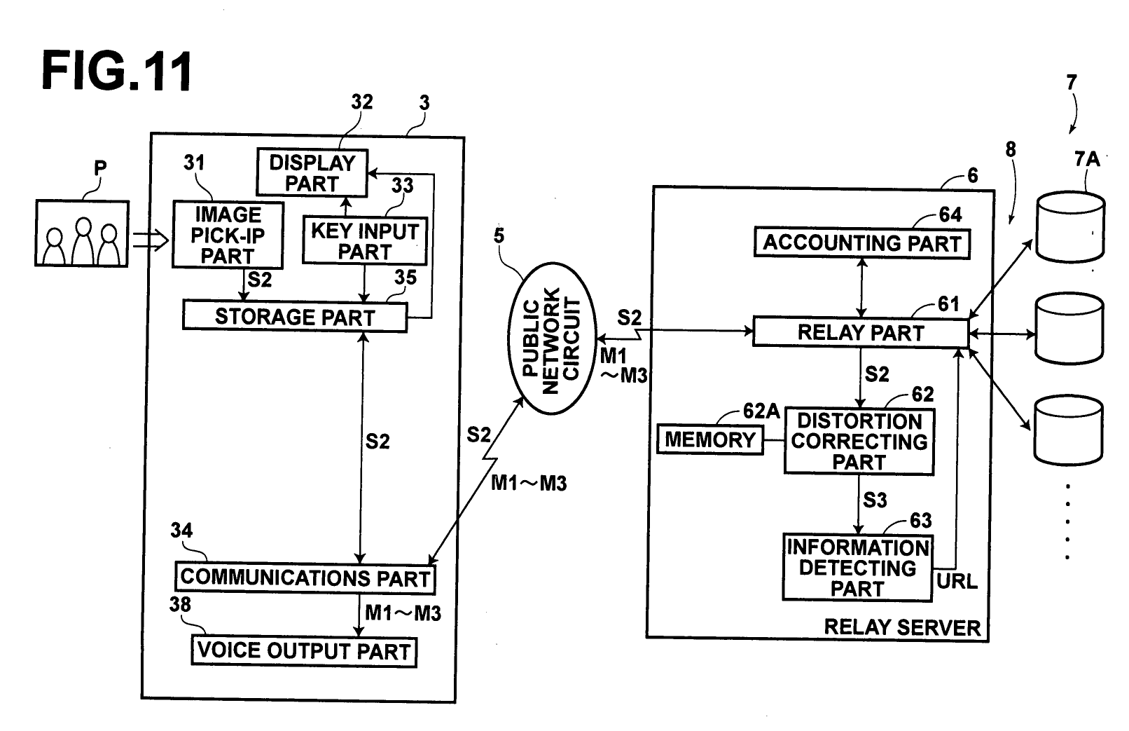

FIG. 11 shows a cellular telephone relay system that is an information transmission system with the information detecting device constructed in accordance with a third embodiment of the present invention. In the third embodiment, the same reference numerals will be applied to the same parts as the first embodiment. Therefore, a detailed description will be omitted unless particularly necessary.

As shown in FIG. 11, in the cellular telephone relay system that is the information transmission system of the third embodiment, data is transmitted and received between a cellular telephone 3 with a built-in camera (hereinafter referred to simply as a cellular telephone 3), a relay server 6, and a server group 7 consisting of a web server, a mail server, etc., through a public network circuit 5 and a network 8.

The cellular telephone 3 in the third embodiment has an image pick-up part 31, a display part 32, a key input part 33, a communications part 34, a storage part 35, and a voice output part 38, as with the cellular telephone 3 of the information transmission system 1 of the second embodiment.

The relay server 6 is equipped with a relay part 61 for relaying the cellular telephone 3 and server group 7; a distortion correcting part 62 and information detecting part 63 corresponding to the distortion correcting part 36, 54 and information detecting parts 37, 55 of the first and second embodiments; and an accounting part 64 for managing the communication charge for the cellular telephone 3. The distortion correcting part 62 is equipped with memory 62A that stores distortion characteristic information corresponding to the type of cellular telephone 3. The memory 62A corresponds to the memory 54A of the second embodiment.

In the third embodiment, the information detecting part 63 has the functions of detecting codes C1 to C3 from the corrected-image data S3 and of inputting URLs corresponding to the codes C1 to C3 to the relay part 61.

If URLs are input from the information detecting part 63, the relay part 61 accesses a web server (for example, 7A) corresponding to the URLs, reads out audio data M1 to M3 stored in that web server, and transmits them to the cellular telephone 3. Note that when the codes C1 to C3 are not embedded in the print P photographed by the cellular telephone 3, that effect is input from the information detecting part 63 to the relay part 61. The relay part 61 transmits electronic mail describing that effect to the cellular telephone 3 so the user of the cellular telephone 3 can find that the photographed-image data S2 transmitted from the cellular telephone 3 does not contain information linked with the audio data M1 to M3.

The accounting part 64 performs the management of the communication charge for the cellular telephone 3. In the third embodiment, if codes C1 to C3 are embedded in the print P, and the relay part 61 accesses the web server 7A to acquire audio data M1 to M3, the accounting part 64 performs accounting. On the other hand, if codes C1 to C3 are not embedded in the print P, accounting is not performed because the relay part 61 does not access the servers 7.

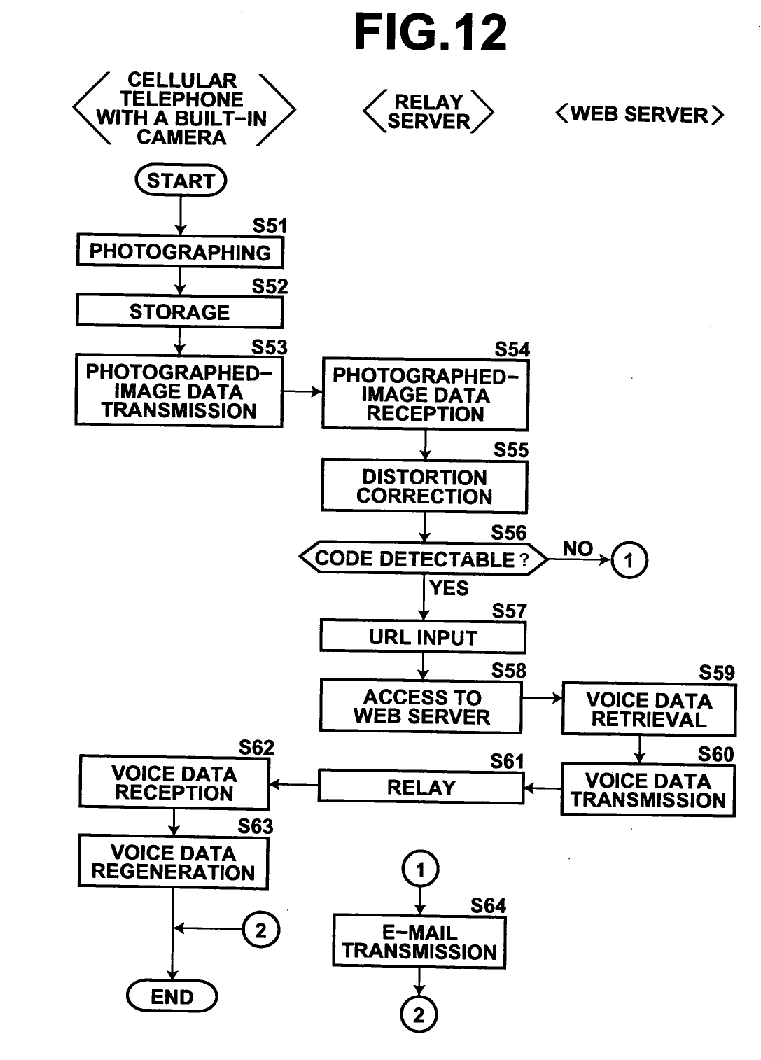

Next, a description will be given of the steps performed in the third embodiment of the present invention. FIG. 12 is a flowchart showing the steps performed in the third embodiment. A print P is delivered to the receiving user. In response to instructions from the receiving user, the image pick-up part 31 photographs the print P and acquires photographed-image data S2 representing the image of the print P (step S51). The storage part 35 stores the photographed-image data S2 temporarily (step S52). The communications part 34 reads out the photographed-image data S2 from the storage part 35 and transmits it to the relay server 6 through a public network circuit 5 (step S53).

The relay part 61 of the relay server 6 receives the photographed-image data S2 (step S54), and the distortion correcting part 62 corrects geometrical distortion contained in the photographed-image data S2 and acquires corrected-image data S3 (step S55). The information detecting part 63 judges whether or not the codes C1 to C3 representing the URLs of the audio data M1 to M3 are detected from the corrected-image data S3 (step S56).

If the judgment in step S56 is YES, the information detecting part 63 detects codes C1 to C3 from the corrected-image data S3, generates URLs from the codes C1 to C3, and inputs them to the relay part 61 (step S67). The relay part 61 accesses the web server 7A through the network 8, based on the URLs (step S58).

The web server 7A retrieves audio data M1 to M3 (step S59) and transmits them to the relay part 61 through the network 8 (step S60). The relay part 61 relays the audio data M1 to M3 and retransmits them to the cellular telephone (step S61).

The communications part 34 of the cellular telephone 3 receives the audio data M1 to M3 (step S62), the voice output part 38 reproduces the audio data M1 to M3 (step S63), and the processing ends.

On the other hand, if the judgment in step S56 is NO, electronic mail, describing that codes C1 to C3 are not embedded in the print P, is transmitted from the relay part 61 to the cellular telephone 3 (step S64), and the processing ends.

In the first through the third embodiments, while the URLs of the audio data M1 to M3 are embedded as digital watermarks, the telephone numbers for persons contained in the print P may be embedded. In this case, the persons in the print P can secretly transmit their telephone numbers to the user of the cellular telephone 3 without becoming known to others. On the other hand, the user of the cellular telephone 3 is able to obtain the telephone numbers of the persons in the print P from the photographed-image data S2 obtained by photographing the print P with the cellular telephone 3, whereby the user of the cellular telephone 3 is able to call the persons contained in the print P.

In the first through the third embodiments, the codes C1 to C3 are detected from the corrected-image data S3 obtained by correcting the photographed-image data S2, but there are cases where the photographing lens of the image pick-up part 31 is high in performance and contains no geometrical distortion or contains little geometrical distortion. In such cases, the codes C1 to C3 can be detected from photographed-image data S2 without correcting the photographed-image data S2.

In the first through the third embodiments, the print P is photographed with the cellular telephone 3 and the audio data M1 to M3 are transmitted to the cellular telephone 3. However, the audio data M1 to M3 may be transmitted to personal computers and reproduced, by reading out an image from the print P with a camera, scanner, etc., connected to personal computers, and obtaining the photographed-image data S2.

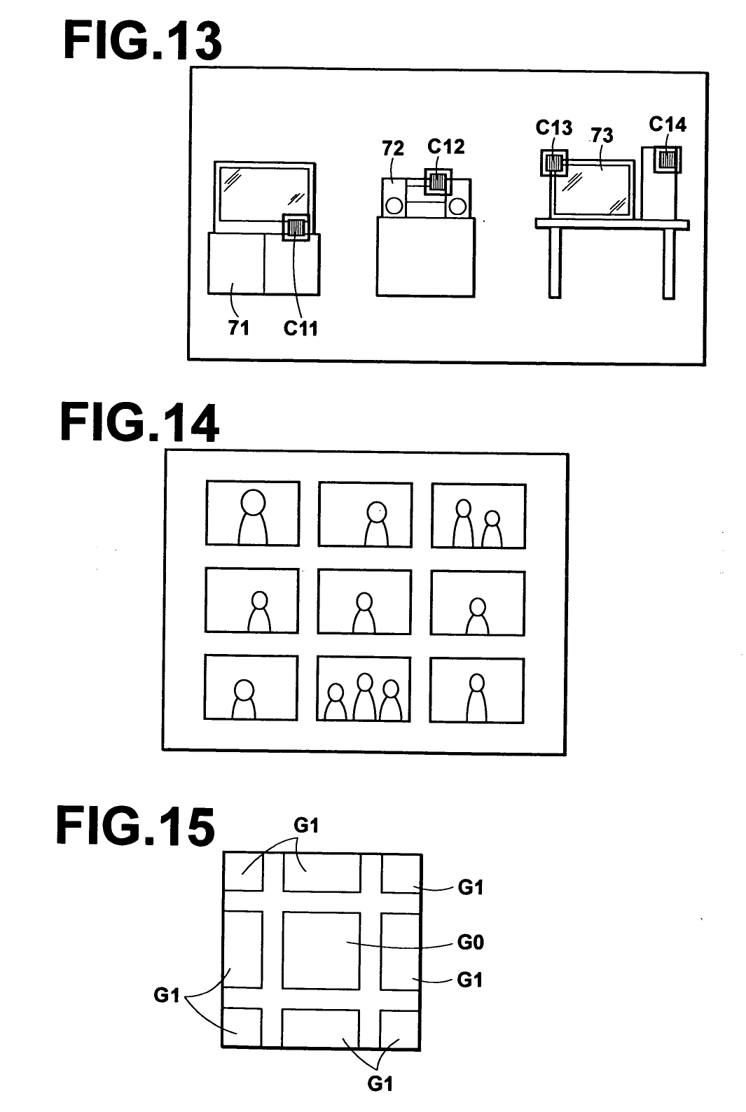

As shown in FIG. 13, in a television 71, stereo 72, and personal computer 73 for reproducing images and voices, by photographing these reproducing means and embedding IDs for specifying the reproducing means in image data S0 representing the photographed image as codes C11 to C13, information-attached image data S1 with the embedded codes C11 to C13 may be printed out. In this case, each reproducing means has the function of receiving and reproducing the audio data, still image data and/or motion image data (hereinafter referred to as audio data and other data.) transmitted from the cellular telephone 3.

And if the print P of the information-attached image data S1 is photographed by the cellular telephone 3, a code for a desired device is detected, and audio data and other data are transmitted to a device having the detected code, then the audio data and other data can be reproduced on that device. For instance, if code C12 is detected from the portion of the stereo 72 in the print P, and audio data is transmitted to the stereo 72 having the device ID corresponding to the code C12, the transmitted audio data can be reproduced on the stereo 72.

Also, in the portion corresponding to the personal computer 73 in the image represented by the image data S1, an application ID representing a specific application for reproducing audio data and other data may be embedded as code C14. In this case, by photographing the print P of the information-attached image data S1 with embedded code C14 and detecting the code C14, by simultaneously transmitting the code C14 of the application ID when transmitting audio data and other data to the personal computer 73, and by booting up the specific application represented by the application ID corresponding to the code C14, the audio data and other data may be reproduced by that application. In this case, by booting up the specific application, previously set audio data and other data may also be reproduced. Also, by booting up the specific application and then transmitting audio data and other data to the personal computer 73 via a network, the audio data and other data may be reproduced on the personal computer 73.

In the first through the third embodiments, audio data is transmitted to the cellular telephone 3. However, the audio data may be reproduced on the cellular telephone 3 by making a telephone call to the cellular telephone 3 instead of transmitting the audio data M1 to M3.

In the embodiment of the information attaching system, codes C1 to C3 are embedded in the original image data S0 obtained by photographing three persons. However, as shown in FIG. 14, in an original image with many persons obtained by photographing many images containing at least one person, codes maybe embedded so that they correspond to the persons. As with the above-described case, the face region of each person is extracted from the original image data S0, and a corresponding code is embedded in the extracted face region.

In the embodiment of the information attaching system, the codes representing the URLs of audio data M1 to M3 are embedded for each photographed object contained in the original image S0. However, in the case where the image data S0 is generated from motion image data, a code representing the URL of that motion image data may be embedded for each photographed object contained in the original image S0.

In the first through the third embodiments, motion image data is transmitted and reproduced on the cellular telephone 3. However, there are cases, depending on the type of cellular telephone 3, in which motion image data cannot be reproduced. For that reason, the server stores a table describing whether or not motion image data can be reproduced, for each type of cellular telephone 3. When transmitting a code or photographed-image data S2 from the cellular telephone 3 to the server, information specifying the type of cellular telephone 3 is transmitted. Only when the type of cellular telephone 3 can reproduce motion image data, it is transmitted from the server to the cellular telephone 3. In the case where the type of cellular telephone 3 cannot reproduce motion image data, only the audio data contained in motion image data is transmitted to the cellular telephone 3. Even in the case where the type of cellular telephone 3 can reproduce motion image data, a picture screen may be transmitted to the cellular telephone 3 so that the user can select either that motion image data is transmitted or that only audio data contained in the motion image data is transmitted.

Incidentally, audio data or motion image data is recorded on a medium such as CD-R, DVD-R, etc., the medium is loaded in reproducing means such as a personal computer, a DVD player, etc., and the recorded audio data or motion image data is played back. In the case where voices or motion images are recorded on a medium, it is sometimes troublesome to select a desired voice, etc. For that reason, by attaching a plurality of index images respectively corresponding to a plurality of voices recorded on a medium to the housing of that medium, embedding a code for specifying the voice corresponding to each index image, photographing a desired index image and transmitting the code attached to the index image to reproducing means, and reproducing the voice corresponding to the received code on the reproducing means, the reproduction of a desired voice can be easily performed.

However, when there are many index images within a photographed image, it will become difficult to know which index image a code is embedded in.

For that reason, when photographing index images, photographing is often performed so that a desired index image is located at the center. A photographed image obtained by such photographing is shown in FIG. 15. As shown in the figure, the photographed image contains a desired index image G0 at the center and portions of other index images G1 around the image G0.

Therefore, in such a case, the area of each index image with an embedded code is computed and only the code obtained from the index image having the largest area is transmitted to the reproducing means. Thus, even in the case where there are many index images in a photographed image, data corresponding to a desired index image can be reproduced by the reproducing means. In this case, it is preferable that the index image with the largest area is displayed so it differs from other index images by blinking that index image or enclosing it with a frame within the photographed image.

Note that the area of an index image may be computed, using a weighting coefficient that becomes greater in weight toward the center of a photographed image. In this case, a weighted area is computed by multiplying the area of an index image by a weighting coefficient corresponding to the location, and only a code obtained from the index image having the largest weighted area is transmitted to reproducing means.

In the first through the third embodiments, the print P, obtained by printing information-attached image data S1, is photographed, and codes are detected from photographed-image data S2 obtained by photographing the print P. However, codes may be detected from photographed-image data S2, obtained by displaying information-attached image S1 on a display such as a CRT display and a liquid crystal display and photographing the displayed image S1. In this case, if information-attached image data S1 is transmitted to a personal computer, a television or means capable of displaying image data, it can be displayed without being printed.

While the present invention has been described with reference to the preferred embodiments thereof, the invention is not to be limited to the details given herein, but may be modified within the scope of the invention hereinafter claimed.

1. An information attaching device for attaching information to an image containing a plurality of photographed objects, and acquiring information-attached image, comprising:
information attaching means for attaching different information to each of a plurality of regions in said image that respectively contain said plurality of photographed objects, and acquiring said information-attached image.

2. The information attaching device as set forth in claim 1, wherein said information attaching means is means for acquiring said information-attached image by hiddenly embedding said information in said image.

3. An information detecting device comprising:
input means for receiving photographed-image data obtained by photographing an image reproducing medium, on which the information-attached image acquired by the information attaching device as set forth in claim 1 is reproduced, with image pick-up means; and
detection means for detecting said information from said photographed-image data for each of said plurality of photographed objects contained in said information-attached image.

4. The information detecting device as set forth in claim 3, further comprising distortion correction means for correcting geometrical distortion contained in said photographed-image data;
wherein said detection means is means for detecting said information from the photographed-image data corrected by said correction means.

5. The information detecting device as set forth in claim 3, wherein said image pick-up means is a camera provided in a portable terminal.

6. The information detecting device as set forth in claim 3, wherein said information is location information representing storage locations of audio data correlated with said plurality of photographed objects, and which further comprises audio data acquisition means for acquiring said audio data, based on said location information.

7. An information attaching method of attaching information to an image containing a plurality of photographed objects, and acquiring information-attached image, comprising the step of:
attaching different information to each of a plurality of regions in said image that respectively contain said plurality of photographed objects, and acquiring said information-attached image.

8. An information detecting method comprising the steps of:
receiving photographed-image data obtained by photographing an image reproducing medium, on which the information-attached image acquired by the method as set forth in claim 7 is reproduced, with image pick-up means; and
detecting said information from said photographed-image data for each of said plurality of photographed objects contained in said information-attached image.

9. A program for causing a computer to execute an information attaching method of attaching information to an image containing a plurality of photographed objects, and acquiring information-attached image, said program comprising:
a procedure of attaching different information to each of a plurality of regions in said image that respectively contain said plurality of photographed objects, and acquiring said information-attached image.

10. A program for causing a computer to execute:
a procedure of receiving photographed-image data obtained by photographing an image reproducing medium, on which the information-attached image acquired by the method as set forth in claim 7 is reproduced, with image pick-up means; and
a procedure of detecting said information from said photographed-image data for each of said plurality of photographed objects contained in said information-attached image.
